(19) United States
(12) Patent Application Publication
(10) Pub. No.: US 2013/0128404 A1
(43) Pub. Date: May 23, 2013

(54) OVERVOLTAGE PROTECTION CIRCUIT

(71) Applicants: YI-XIN TU, Shenzhen City (CN); JIN-LIANG XIONG, Shenzhen City (CN); HAI-QING ZHOU, Shenzhen City (CN)

(72) Inventors: YI-XIN TU, Shenzhen City (CN); JIN-LIANG XIONG, Shenzhen City (CN); HAI-QING ZHOU, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/570,206

(22) Filed: Aug. 8, 2012

(30) Foreign Application Priority Data
Nov. 22, 2011 (CN) 201120466579.2

(51) Int. Cl. H02H 3/20

(52) U.S. Cl. 361/86

(57) ABSTRACT

A protection circuit that protects a load charged by a power supply. The protection circuit includes a reference voltage set circuit, a sampling circuit, a switch, and a comparator. The reference voltage set circuit provides a reference voltage. The sampling circuit is electrically connected to the power supply and provides a sampling voltage based on a charge voltage output from the power supply to the load. The switch is electrically connected between the power supply and the load. The comparator includes a non-inverting input terminal electrically connected to the reference voltage set circuit, an inverting input terminal electrically connected to the sampling circuit, and an output terminal electrically connected to the switch. The comparator compares the sampling voltage with the reference voltage, and controls the switch to turn on or off according to the comparison.

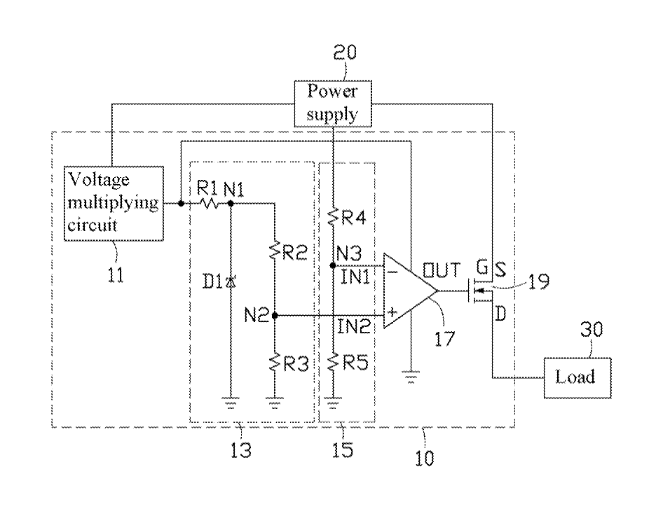

### BACKGROUND

1. Technical Field

The disclosure generally relates to overvoltage protection circuits, and particularly to an overvoltage protection circuit for portable electronic devices.

2. Description of Related Art

Portable electronic devices such as mobile phones, personal digital assistants, digital cameras etc. may include a universal serial bus (USB) port used to connect to other electronic device, such as a computer, for data transmission and charging. A charging circuit of the portable electronic device converts a charging voltage (commonly about 5V) provided by the computer to a rated voltage (commonly about 3.7V) for charging the portable electronic device via the USB port.

However, during charging, if the charging voltage output from the computer is unstable, the rated voltage for portable electronic device may also become unstable and damage the portable electronic device.

Therefore, there is room for improvement within the art.

### BRIEF DESCRIPTION OF THE DRAWING

Many aspects of the present disclosure can be better understood with reference to the following drawing. The components in the drawing are not necessarily drawn to scale, the emphasis instead being placed upon clearly illustrating the principles of the disclosure.

The FIGURE is a circuit diagram of an overvoltage protection circuit, according to an exemplary embodiment of the disclosure.

### DETAILED DESCRIPTION

The FIGURE is a circuit diagram of an overvoltage protection circuit 10 according to an exemplary embodiment of the disclosure. The overvoltage protection circuit 10 is used to control a power supply 20 to provide power supply to a load 30.

The overvoltage protection circuit 10 includes a voltage multiplying circuit 11, a reference voltage set circuit 13, a sampling circuit 15, a comparator 17, and a switch 19.

An input of the multiplying circuit 11 is electrically connected to the power supply 20, and an output of the multiplying circuit 11 is connected to the reference circuit 13 and the comparator 17. The multiplying circuit 11 increases a voltage output (e.g., 5V) from the power supply 20, and outputs the increased voltage (e.g., 10V) to the reference circuit 13 and the comparator 17 via the output.

The reference circuit 13 includes a voltage stabilizing resistor R1, a first voltage dividing resistor R2, a second voltage dividing resistor R3, and a voltage stabilizing diode D. The resistors R1, R2, and R3 are connected in series between the multiplying circuit 11 and ground. A cathode of the diode D1 is electrically connected to a first node N1 between the resistor R1 and the resistor R2. An anode of the diode D1 is grounded. The resistor R1 and the diode D1 cooperatively stabilize the doubled voltage and output the stabilized voltage to the resistors R2, R3. A second node N2 connected between the resistor R2 and the resistor R3 is electrically connected to the comparator 17 to provide a reference voltage to the comparator 17. The reference voltage can be adjusted by changing a resistance of the resistor R3.

The sampling circuit 15 includes a third voltage dividing resistor R4 and a fourth voltage dividing resistor R5 connected between the power supply 20 and ground. A third node N3 between the resistor R4 and the resistor R5 is electrically connected to the comparator 17 to provide a sampling voltage based on the charging voltage supplied to the load 30.

The comparator 17 includes an inverting input terminal IN1, a non-inverting input terminal IN2, and an output terminal OUT. The inverting terminal IN1 is electrically connected to the third node N3 to obtain the sampling voltage. The non-inverting input terminal IN2 is electrically connected to the second node N2 to obtain the reference voltage. The output terminal OUT is electrically connected to the switch 19. The comparator 17 compares the sampling voltage with the reference voltage and controls the switch 19 to turn on or off according the comparison. When the sampling voltage exceeds the reference voltage, the comparator 17 controls the switch 19 to turn off. Otherwise, when the sampling voltage does not exceed the reference voltage, the comparator 17 controls the switch 19 to turn on.

In this embodiment, the switch 19 is a metal-oxide-semiconductor field-effect transistor (MOSFET). A gate G of the switch 19 is electrically connected to the output terminal OUT. A source S of the switch 19 is electrically connected to the power supply 20. A drain D of the switch 19 is electrically connected to the load 30. When the switch 19 is turned off, the power supply 20 stops charging the load 30. When the switch 19 is turned on, the power supply 20 charges the load 30.

The overvoltage protection circuit 10 can set the reference voltage according to a maximal charging voltage of the load 30 and stops charging the load 30 once the charging voltage exceeds the reference voltage to protect the load 30 and prevents damage to the load 30 due to an overvoltage.

It is believed that the exemplary embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. A overvoltage protection circuit that protects a load charged by a power supply, the protection circuit comprising:
a reference voltage set circuit providing a reference voltage based on the load;
a sampling circuit electrically connected to the power supply, the sampling circuit providing a sampling voltage based on a charge voltage output from the power supply to the load;
a switch electrically connected between the power supply and the load; and
a comparator comprising a non-inverting input terminal electrically connected to the reference voltage set circuit, an inverting input terminal electrically connected to the sampling circuit, and an output terminal electrically connected to the switch; the comparator comparing the sampling voltage with the reference voltage, and controlling the switch to turn on or off according to the comparison.

2. The overvoltage protection circuit of claim 1, wherein the switch is a metal-oxide-semiconductor field-effect transistor (MOSFET), a gate of the switch electrically connected to the output terminal; a source of the switch electrically connected to the power supply; a drain of the switch electrically connected to the load.

3. The overvoltage protection circuit of claim 2, wherein when the sampling voltage exceeds the reference voltage, the comparator controls the switch to turn off.

4. The overvoltage protection circuit of claim 1, wherein when the sampling voltage does not exceed the reference voltage, the comparator controls the switch to turn on.

5. The overvoltage protection circuit of claim 1, further comprises a voltage multiplying circuit, an input of the voltage multiplying circuit is electrically connected to the power supply, and an output of the voltage multiplying circuit is electrically connected to the reference voltage set circuit and the sampling circuit, the voltage multiplying circuit increases a voltage output from the power supply, and outputs the increased voltage to the reference voltage set circuit and the sampling circuit via the output.

6. The overvoltage protection circuit of claim 1, wherein the reference voltage set circuit comprises a voltage stabilizing resistor, a first voltage dividing resistor, a second voltage dividing resistor and a voltage stabilizing diode, the voltage stabilizing resistor; the first voltage dividing resistor, the second voltage dividing resistor are connected in series between the power supply and ground; a cathode of the voltage stabilizing diode is electrically connected to a first node between the voltage stabilizing resistor and the first voltage dividing resistor, an anode of the voltage stabilizing diode is grounded; a second node between the first voltage dividing resistor and the second voltage dividing resistor is electrically connected to the comparator to provide the reference voltage.

7. The overvoltage protection circuit of claim 1, wherein sampling circuit comprises a third voltage dividing resistor and a fourth voltage dividing resistor connected in series between the power supply and ground, a third node between the third voltage dividing resistor and the fourth voltage dividing resistor is electrically connected to the comparator to provide the sampling voltage.
